(19) United States
(12) Patent Application Publication
(10) Pub. No.: US 2025/0244873 A1
(43) Pub. Date: Jul. 31, 2025

(54) STORAGE SYSTEM

(71) Applicant: Hitachi Vantara, Ltd., Yokohama-shi (JP)

(72) Inventor: Kentaro SHIMADA, Tokyo (JP)

(73) Assignee: Hitachi Vantara, Ltd., Yokohama-shi (JP)

(21) Appl. No.: 18/884,935

(22) Filed: Sep. 13, 2024

(30) Foreign Application Priority Data
Jan. 31, 2024 (JP) 2024-013419

(51) Int. Cl. G06F 3/06

(52) U.S. Cl. CPC G06F 3/061; G06F 3/0655; G06F 3/0671

(57) ABSTRACT

A storage system is provided that is connected to a host machine and inputs or outputs data according to a request from the host machine, the storage system including a first enclosure mounted with a controller including a processor that controls the storage system, and one or more second enclosures mounted with a storage device that stores data transmitted from the host machine, wherein an IO device that receives data stored in the storage system from the host machine and transmits data output by the storage system to the host machine is further provided, and the IO device is mounted in the second enclosure.

### BACKGROUND OF THE INVENTION

### 1. Field of the Invention

The present invention relates to a storage system.

### 2. Description of the Related Art

Conventionally, there is a technique described in JP 2019-91152 A in order to reduce electric power of a storage system that is strictly required to improve performance. This publication describes that “the electric power is appropriately reduced according to the host I/O” and that “a storage system includes one or more storage drives and a controller that controls the one or more storage drives, the one or more storage drives each having a plurality of power consumption states, the plurality of power consumption states capable of responding to a read request and a write request, and having different electric power and different response performance, and the controller monitoring a frequency of a predetermined type of I/O to each of the one or more storage drives and setting each of the one or more storage drives to a state selected from the plurality of power consumption states based on the frequency”.

In the storage system described in JP 2019-91152 A, as described above, electric power is reduced by setting the storage drive to a state selected from a plurality of power consumption states. On the other hand, in a storage system that receives an input/output request of data from a host machine and inputs/outputs data, a processor is mounted in a controller thereof for internal control. This processor is operating at high speed to achieve high processing performance, and accordingly consumes a lot of power. In recent years, performance required for a storage system has increased, and power consumption of a processor mounted on a controller of the storage system has become very large, and as a result, this involved a lot of heat generation. As a result, electric power and heat generation in the controller enclosure that inputs the controller increase.

In addition, the storage system includes a host interface that is connected to the host machine and transmits and receives data to and from the host machine. The host interface includes an IO device including a protocol control unit for protocol processing related to transmission and reception of data with the host machine and a transferring processing unit that performs data transfer with the host machine. In recent years, data transfer between the host machine and the storage system is also very fast, and power consumption and heat generation in such IO devices are also increasing. Therefore, when the IO device and the processor are arranged in the controller enclosure, power consumption and heat generation accompanying the power consumption concentrate on the controller enclosure. In particular, since the processor controls the entire controller, the processor is often physically placed at the center of the structure of the controller enclosure that inputs the controller. On the other hand, the host interface is often placed on the outer edge portion of the controller enclosure, for example, on the back surface portion of the controller enclosure in order to connect a transfer cable for transferring data with the host machine. As a result, when air cooling is performed in the controller enclosure, the IO device working as the host interface often receives a large amount of heat generated by the processor, and power, heat generation, and cooling become larger problems. In order to solve this problem, if the IO device is input by providing another dedicated enclosure instead of the controller enclosure, the number of enclosures increases, and the space saving property of the storage system is impaired.

Furthermore, in the expansion enclosure that is an enclosure in which a large number of storage devices are mounted, the storage devices input/output data at high speed when instructed to input and output data by the controller, but the usage in which a large number of storage devices mounted in the expansion enclosure input and output data all at one time is relatively rare. For this reason, in the expansion enclosure in which only the storage devices are mounted, even if the mounted number of storage devices is large, all the storage devices rarely perform input and output of data at the same time, and accordingly, heat generation due to power consumed by the storage devices does not become a big problem.

### SUMMARY OF THE INVENTION

In the above-described prior art, heat generation and cooling of an IO device which is a device performing input/output (input/output) are not considered. This point will be described.

The performance improvement of the storage system increases power consumption of the processor. The increase in power consumption of the processor also increases the heat generation of the processor. Thus, measures such as air cooling of the processor are taken.

The performance improvement of the storage system increases power consumption and heat generation of not only the processor, but also the IO device. When the IO device is located in the vicinity of the processor, heat generating portions are concentrated. In particular, when the IO device is located on the leeward side of the cooling wind that air-cools the processor, the IO device is affected by heat generation of the processor, and cooling becomes difficult.

Therefore, an object of the present invention is to realize an efficient countermeasure against heat generation as the entire storage system in consideration of heat generation of an IO device in addition to heat generation of a processor.

In order to achieve the above object, one of the representative storage systems of the present invention is a storage system that is connected to a host machine and inputs or outputs data according to a request from the host machine, the storage system including: a first enclosure (controller enclosure) in which a controller including a processor that controls the storage system is mounted; and one or more second enclosures (expansion enclosures) in which a storage device that stores data transmitted from the host machine is mounted, where an IO device that receives data to be stored in the storage system from the host machine and transmits data output by the storage system to the host machine is further provided, and the IO device is mounted in the second enclosure (expansion enclosure).

According to the present invention, it is possible to realize an efficient countermeasure against heat generation of the storage system. Problems, configurations, and effects other than those described above will be clarified by the description of the following embodiments.

### BRIEF DESCRIPTION OF THE DRAWINGS

FIGS. 1A and 1B are explanatory diagrams of a storage system according to a first example;

FIG. 2 is a sequence diagram for explaining processing of a read request according to the first example;

FIG. 3 is a sequence diagram for explaining processing of a write request according to the first example;

FIGS. 4A and 4B are explanatory diagrams of a storage system according to a second example;

FIG. 5 is a sequence diagram for explaining a process of a read request according to the second example; and

FIG. 6 is a sequence diagram for explaining a process of a write request according to the second example.

### DESCRIPTION OF THE PREFERRED EMBODIMENTS

Hereinafter, examples will be described with reference to the drawings.

### First Example

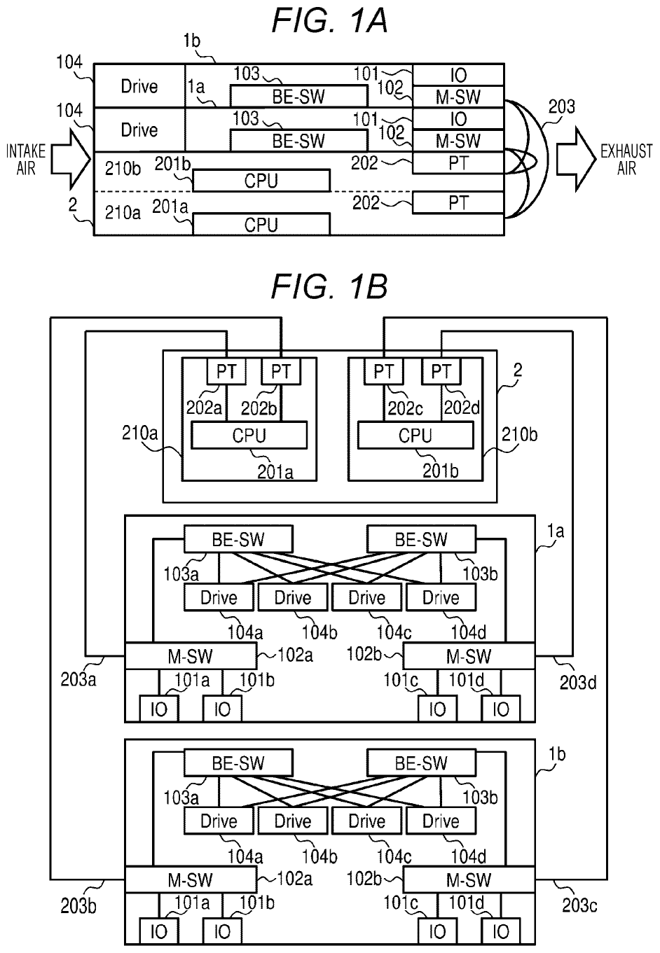

FIG. 1 is an explanatory diagram of a storage system according to a first example. FIG. 1 (a) is a model figure of a storage system of a first example as viewed from the side surface (side view), and FIG. 1 (b) is a logical connection diagram of the storage system of the first example.

As illustrated in FIG. 1 (a), in the storage system of the first example, two expansion enclosures 1 (1a, 1b) are provided on a controller enclosure 2. Note that the number of expansion enclosures 1a and 1b is not limited to two, and may be any number of one or more. The controller enclosure corresponds to a first enclosure in the claims. The expansion enclosure corresponds to a second enclosure in the claims.

The controller enclosure 2 is equipped with two controllers 210 (210a, 210b).

The controller 210a includes a central processing unit (CPU) 201a and two pass through modules 202 (202a, 202b).

The controller 210b includes a CPU 201b and two pass through modules 202 (202c, 202d).

The number of CPUs 201a and 201b mounted on the controllers 210a and 210b is not limited to one, and may be any number of one or more. The number of pass through modules 202a is not limited to two, and may be any number of one or more.

The expansion enclosure 1 includes four IO devices 101 (101a to 101d), two unified switches 102 (102a, 102b), and two backend switches 103 (103a, 103b), and has four storage devices 104 (104a to 104d) mounted thereon.

The IO device 101a and the IO device 101b are connected to the unified switch 102a. The unified switch 102a is connected to the IO device 101a, the IO device 101b, and the backend switch 103a.

The IO device 101c and the IO device 101d are connected to the unified switch 102b. The unified switch 102b is connected to the IO device 101c, the IO device 101d, and the backend switch 103b.

The backend switch 103a is connected to the unified switch 102a and the storage devices 104a to 104d.

The backend switch 103b is connected to the unified switch 102b and the storage devices 104a to 104d.

Note that the number of IO devices 101a to 101d is not limited to four, and may be any number of two or more. The number of unified switches 102a and 102b is not limited to two, and may be any number of two or more. The number of backend switches 103a and 103b is not limited to two, and may be any number of two or more. The number of storage devices 104a to 104d is not limited to 4, and may be any number of one or more.

The unified switch 102a of the expansion enclosure 1a is connected to the pass through module 202a of the controller enclosure 2 by the unified connecting cable 203a.

The unified switch 102b of the expansion enclosure 1a is connected to the pass through module 202d of the controller enclosure 2 by the unified connecting cable 203d.

The unified switch 102a of the expansion enclosure 1b is connected to the pass through module 202b of the controller enclosure 2 by the unified connecting cable 203b.

The unified switch 102b of the expansion enclosure 1b is connected to the pass through module 202c of the controller enclosure 2 by the unified connecting cable 203c.

The CPU 201 is a processor that controls the storage system.

The storage device 104 stores data transmitted from the host machine.

The IO device 101 performs processes related to data transmission and reception with the host machine. The IO device 101 includes a protocol control unit for a protocol processing related to transmission and reception of data with the host machine and a transferring processing unit that performs data transfer with the host machine.

The pass through module 202 relays data.

When write is requested from the host machine, the write request is sent to the CPU 201 via the IO device 101, the unified switch 102, the unified connecting cable 203, and the pass through module 202. The CPU 201 writes data in the storage device 104 via the pass through module 202, the unified connecting cable 203, the unified switch 102, and the backend switch 103.

In a case where the read is requested from the host machine, the read request is sent to the CPU 201 via the IO device 101, the unified switch 102, the unified connecting cable 203, and the pass through module 202. The CPU 201 reads data from the storage device 104 via the pass through module 202, the unified connecting cable 203, the unified switch 102, and the backend switch 103, and transmits a read result to the host machine via the pass through module 202, the unified connecting cable 203, the unified switch 102, and the IO device 101.

The expansion enclosure 1 and the controller enclosure 2 use the predetermined surface of the enclosure for a cable for performing host calculation and data transfer and wiring for connecting the unified connecting cable 203. The pass through module 202, the unified switch 102, and the IO device 101 are arranged in the vicinity of a surface used for wiring. For the sake of convenience, a surface used for the wiring is referred to as a back surface, and a surface facing the back surface is referred to as a front surface. Since the backend switch 103 does not require wiring with the outside of the enclosure, it does not need to be disposed in the vicinity of the back surface.

Although not illustrated, the storage system has a mechanism for introducing cooling wind into the enclosure. The front surface is the intake side of the cooling wind, and the back surface is the exhaust side of the cooling wind.

The CPU 201 is located at the central portion of the controller enclosure 2. The storage device 104 is disposed on the intake side of the expansion enclosure 1.

On the leeward side of the CPU 201 in the controller enclosure 2, the pass through module 202 exists, and the IO device 101 does not exist. Since the IO device 101 is disposed in the expansion enclosure 1, it is not on the lee side of the CPU 201.

Therefore, in the storage system of the first example, the IO device is not arranged in the controller enclosure but is arranged in the expansion enclosure together with the storage device. Therefore, heat generation can be dispersed to the controller enclosure and the expansion enclosure without increasing the number of enclosures, and efficient heat generation countermeasures can be taken.

Note that in the storage system, process is made redundant by two controllers 210. The IO device 101 mounted on the expansion enclosure 1 is controlled by a processor included in one controller among the controllers 210 mounted on the controller enclosure 2. The IO device 101 transmits data received from the host machine to the processor of one controller 210, and receives data to be transmitted to the host machine from the processor of one controller 210.

On the other hand, the storage device 104 mounted on the expansion enclosure 1 is controlled by the processors of the two controllers 210 mounted on the controller enclosure 2. The storage device 104 receives data to be input from the processors of the two controllers, and transmits data output by the storage device to the processors of the two or more controllers. In this way, the storage device 104 can transmit and receive data to and from any processor of the two redundant controllers 210. In addition, in a case where data is transmitted and received to and from two controllers 210 at the same time, the performance of transmission and reception of data as viewed from the storage device 104 can be doubled as compared with a case where data is transmitted and received to and from only one controller at most, so that the performance of transmission and reception of data in the storage device can be enhanced.

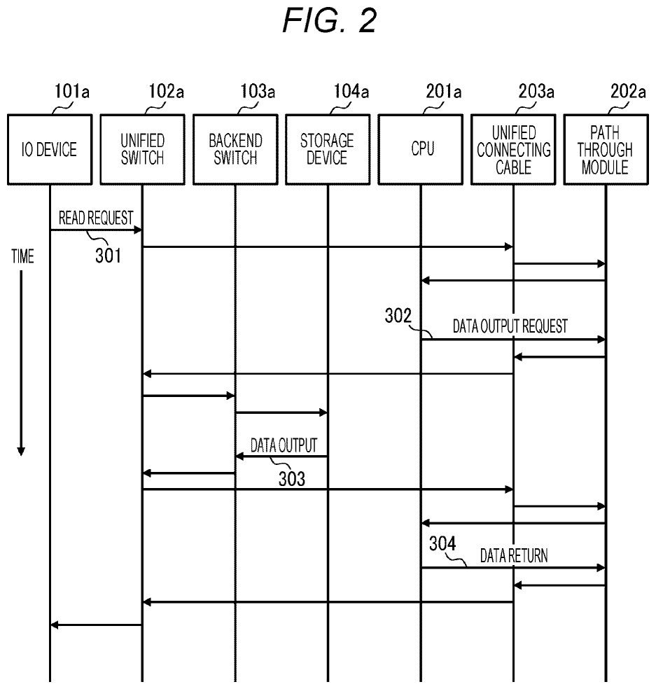

FIG. 2 is a sequence diagram for explaining processing of a read request according to the first example. When receiving the read request from the host machine, the IO device 101a transmits the same as the read request 301 to the CPU 201a. The read request 301 is received by the CPU 201a via the unified switch 102a, the unified connecting cable 203a, and the pass through module 202a.

The CPU 201a that has received the read request 301 transmits a data output request 302 to the storage device 104a. The data output request 302 is received by the storage device 104a via the pass through module 202a, the unified connecting cable 203a, the unified switch 102a, and the backend switch 103a.

The storage device 104a that has received the data output request 302 reads out the requested data and transmits the read data to the CPU 201a as a data output 303. The data output 303 is received by the CPU 201a via the backend switch 103a, the unified switch 102a, the unified connecting cable 203a, and the pass through module 202a.

The CPU 201a that has received the data output 303 extracts data transmitted from the storage device 104a to the IO device 101a from the data output 303 and transmits the data as a data return 304. The data return 304 is received by the IO device 101a via the pass through module 202a, the unified connecting cable 203a, and the unified switch 102a. The IO device 101a returns a read response including read data to the host machine based on the data return 304.

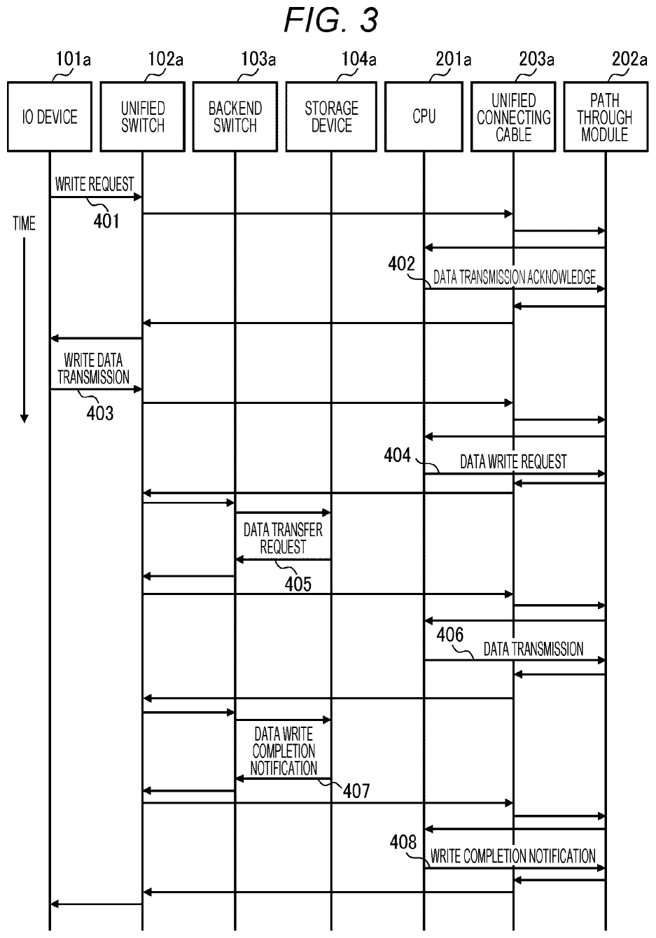

FIG. 3 is a sequence diagram for explaining processing of a write request according to the first example. When receiving the write request from the host machine, the IO device 101a transmits the same as the write request 401 to the CPU 201a. The write request 401 is received by the CPU 201a via the unified switch 102a, the unified connecting cable 203a, and the pass through module 202a.

The CPU 201a that has received the write request 401 transmits a data transfer acknowledge 402 to the IO device 101a. The data transfer acknowledge 402 is received by the IO device 101a via the pass through module 202a, the unified connecting cable 203a, and the unified switch 102a. The IO device 101a transmits the data transfer acknowledge 402 to the host machine, and receives the write data 403 from the host machine.

When receiving the write data 403 from the host machine, the IO device 101a transmits the write data 403 to the CPU 201a. The write data 403 is received by the CPU 201a via the unified switch 102a, the unified connecting cable 203a, and the pass through module 202a.

The CPU 201a that has received the write data 403 transmits a data write request 404 to the storage device 104a. The data write request 404 is received by the storage device 104a via the pass through module 202a, the unified connecting cable 203a, the unified switch 102a, and the backend switch 103a.

The storage device 104a that has received the data write request 404 transmits a data transfer request 405 to the CPU 201a. The data transfer request 405 is received by the CPU 201a via the backend switch 103a, the unified switch 102a, the unified connecting cable 203a, and the pass through module 202a.

The CPU 201a that has received the data transfer request 405 transmits the write data received in the write data 403 to the storage device 104a as the data transmission 406. The data transmission 406 is received by the storage device 104a via the pass through module 202a, the unified connecting cable 203a, the unified switch 102a, and the backend switch 103a.

The storage device 104a that has received the data transmission 406 extracts and inputs the write data from the data transmission 406, and transmits a data write completion notification 407 to the CPU 201a. The data write completion notification 407 is received by the CPU 201a via the backend switch 103a, the unified switch 102a, the unified connecting cable 203a, and the pass through module 202a.

The CPU 201a that has received the data write completion notification 407 transmits a write completion notification 408 to the IO device 101a. The write completion notification 408 is received by the IO device 101a via the pass through module 202a, the unified connecting cable 203a, and the unified switch 102a. The IO device 101a returns a response indicating the write completion to the host machine based on the write completion notification 408.

### Second Example

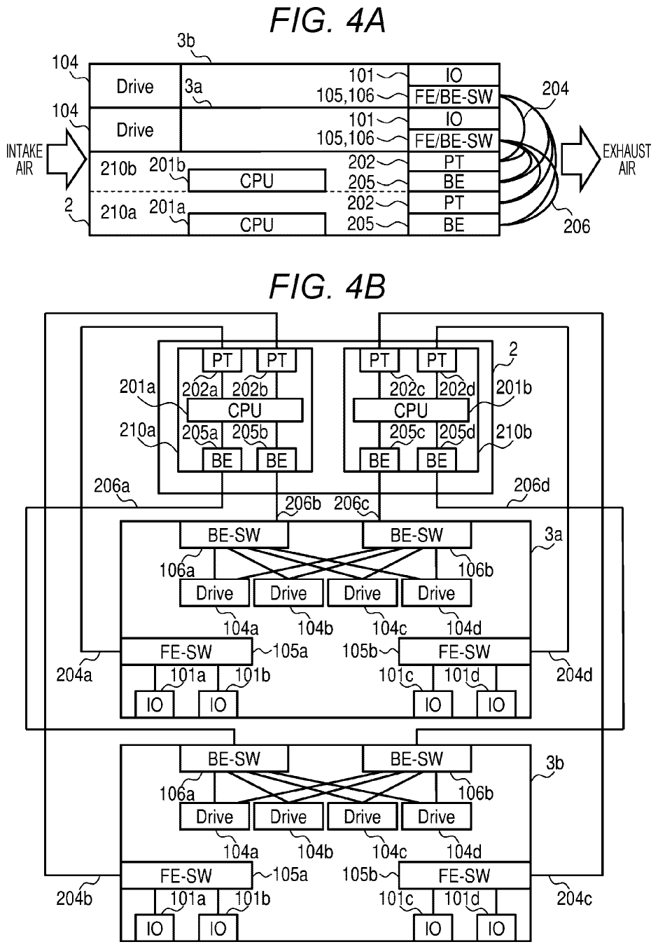

FIG. 4 is an explanatory diagram of a storage system according to a second example. FIG. 4 (a) is a model figure of a storage system of a second example as viewed from the side surface, and FIG. 4 (b) is a logical connection diagram of the storage system of the second example.

As illustrated in FIG. 4 (a), in the storage system of the second example, two expansion enclosures 3 (3a, 3b) are provided on a controller enclosure 2. Note that the number of expansion enclosures 3a and 3b is not limited to two, and may be any number of one or more.

The controller enclosure 2 is equipped with two controllers 210 (210a, 210b).

The controller 210a includes a central processing unit (CPU) 201a, two pass through modules 202 (202a, 202b), and two backend connecting modules 205 (205a, 205b).

The controller 210b includes a CPU 201b, two pass through modules 202 (202c, 202d), and two backend connecting modules 205 (205c, 205d).

The number of CPUs 201a and 201b mounted on the controllers 210a and 210b is not limited to one, and may be any number of one or more. The number of pass through modules 202a is not limited to two, and may be any number of one or more. The number of backend connecting modules 205a and 205b is not limited to two, and may be any number of one or more.

The expansion enclosure 3 includes four IO devices 101 (101a to 101d), two front end switches 105 (105a, 105b), and two backend switches 106 (106a, 106b), and has four storage devices 104 (104a to 104d) mounted thereon.

The IO device 101a and the IO device 101b are connected to the front end switch 105a.

The IO device 101c and the IO device 101d are connected to the front end switch 105b.

The backend switch 106a is connected to the storage devices 104a to 104d.

The backend switch 106b is connected to the storage devices 104a to 104d.

Note that the number of IO devices 101a to 101d is not limited to four, and may be any number of two or more. The number of front end switches 105a and 105b is not limited to two, and may be two or more. The number of backend switches 106a and 106b is not limited to two, and may be any number of two or more. The number of storage devices 104a to 104d is not limited to 4, and may be any number of one or more.

The front end switch 105a of the expansion enclosure 3a is connected to the pass through module 202a of the controller enclosure 2 by the IO connecting cable 204a.

The front end switch 105b of the expansion enclosure 3a is connected to the pass through module 202d of the controller enclosure 2 by the IO connecting cable 204d.

The front end switch 105a of the expansion enclosure 3b is connected to the pass through module 202b of the controller enclosure 2 by the IO connecting cable 204b.

The front end switch 105b of the expansion enclosure 3b is connected to the pass through module 202c of the controller enclosure 2 by the IO connecting cable 204c.

The backend switch 106a of the expansion enclosure 3a is connected to the backend connecting module 205b of the controller enclosure 2 by the backend connecting cable 206b.

The backend switch 106b of the expansion enclosure 3a is connected to the backend connecting module 205c of the controller enclosure 2 by the backend connecting cable 206c.

The backend switch 106a of the expansion enclosure 3b is connected to the backend connecting module 205a of the controller enclosure 2 by the backend connecting cable 206a.

The backend switch 106b of the expansion enclosure 3b is connected to the backend connecting module 205d of the controller enclosure 2 by the backend connecting cable 206d.

In a case where write is requested from the host machine, the write request is sent to the CPU 201 via the IO device 101, the front end switch 105, the IO connecting cable 204, and the pass through module 202. The CPU 201 writes data in the storage device 104 via the backend connecting module 205, the backend connecting cable 206, and the backend switch 106.

In a case where read is requested from the host machine, the read request is sent to the CPU 201 via the IO device 101, the front end switch 105, the IO connecting cable 204, and the pass through module 202. The CPU 201 reads data from the storage device 104 via the backend connecting module 205, the backend connecting cable 206, and the backend switch 106, and transmits a read result to the host machine via the pass through module 202, the IO connecting cable 204, the front end switch 105, and the IO device 101.

The expansion enclosure 3 and the controller enclosure 2 use a predetermined surface of the enclosure for cables for transferring data with the host machine and wiring for connecting the IO connecting cable 204 and the backend connecting cable 206. The pass through module 202, the backend connecting module 205, the front end switch 105, the backend switch 106, and the IO device 101 are arranged in the vicinity of a back surface which is a surface used for wiring.

As in the first example, the pass through module 202 exists and the IO device 101 does not exist on the leeward side of the CPU 201 in the controller enclosure 2. Since the IO device 101 is disposed in the expansion enclosure 3, it is not on the lee side of the CPU 201. Therefore, heat generation can be dispersed to the controller enclosure and the expansion enclosure without increasing the number of enclosures, and efficient heat generation countermeasures can be taken.

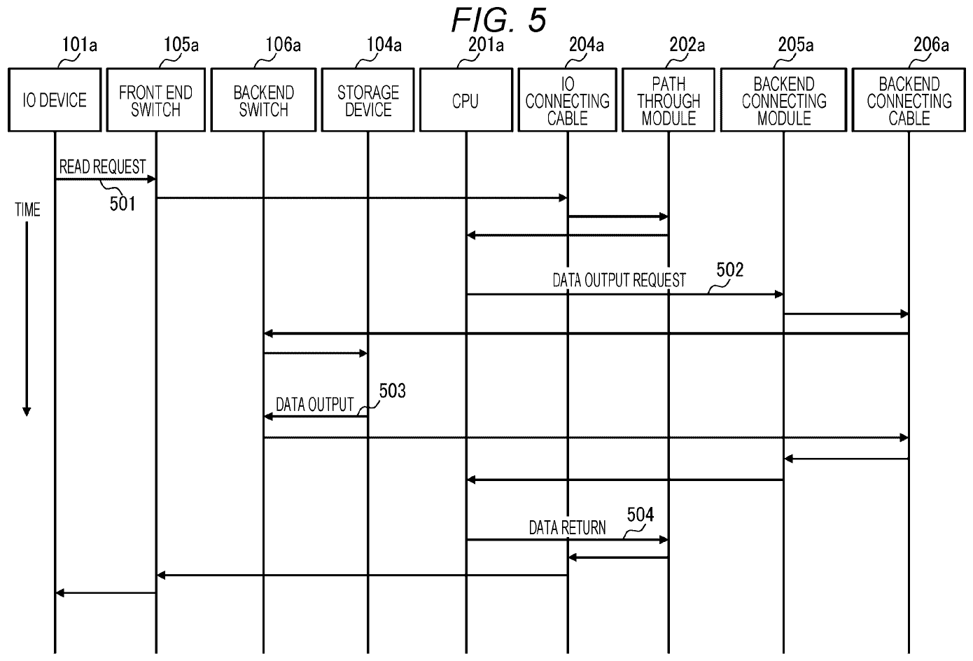

FIG. 5 is a sequence diagram for explaining processing of a read request according to the second example. When receiving the read request from the host machine, the IO device 101a transmits the same as the read request 501 to the CPU 201a. The read request 501 is received by the CPU 201a via the front end switch 105a, the IO connecting cable 204a, and the pass through module 202a.

The CPU 201a that has received the read request 501 transmits a data output request 502 to the storage device 104a. The data output request 502 is received by the storage device 104a via the backend connecting module 205a, the backend connecting cable 206a, and the backend switch 106a.

The storage device 104a that has received the data output request 502 reads out the requested data and transmits the read data to the CPU 201a as a data output 503. The data output 503 is received by the CPU 201a via the backend switch 106a, the backend connecting cable 206a, and the backend connecting module 205a.

The CPU 201a that has received the data output 503 extracts data transmitted from the storage device 104a to the IO device 101a from the data output 503 and transmits the data as a data return 504. The data return 504 is received by the IO device 101a via the pass through module 202a, the IO connecting cable 204a, and the front end switch 105a. The IO device 101a returns a read response including read data to the host machine based on the data return 504.

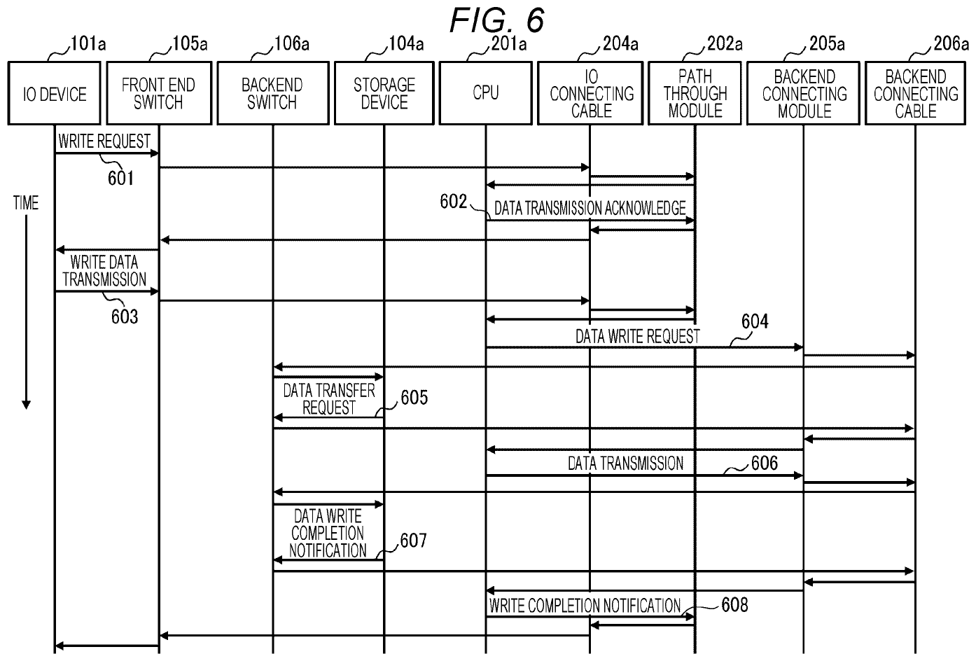

FIG. 6 is a sequence diagram for explaining processing of a write request according to the second example. When receiving the write request from the host machine, the IO device 101a transmits the same as the write request 601 to the CPU 201a. The write request 601 is received by the CPU 201a via the front end switch 105a, the IO connecting cable 204a, and the pass through module 202a.

The CPU 201a that has received the write request 601 transmits a data transfer acknowledge 602 to the IO device 101a. The data transfer acknowledge 602 is received by the IO device 101a via the pass through module 202a, the IO connecting cable 204a, and the front end switch 105a. The IO device 101a transmits the data transfer acknowledge 402 to the host machine, and receives the transmission of the write data 603 from the host machine.

When receiving the write data 603 from the host machine, the IO device 101a transmits the write data 603 to the CPU 201a. The write data 603 is received by the CPU 201a via the front end switch 105a, the IO connecting cable 204a, and the pass through module 202a.

The CPU 201a that has received the write data 603 transmits a data write request 604 to the storage device 104a. The data write request 604 is received by the storage device 104a via the backend connecting module 205a, the backend connecting cable 206a, and the backend switch 106a.

The storage device 104a that has received the data write request 604 transmits a data transfer request 605 to the CPU 201a. The data transfer request 605 is received by the CPU 201a via the backend switch 106a, the backend connecting cable 206a, and the backend connecting module 205a.

The CPU 201a that has received the data transfer request 605 transmits the write data received in the write data 603 to the storage device 104a as the data transmission 606. The data transmission 606 is received by the storage device 104a via the backend connecting module 205a, the backend connecting cable 206a, and the backend switch 106a.

The storage device 104a that has received the data transmission 606 extracts and inputs the write data from the data transmission 606, and transmits a data write completion notification 607 to the CPU 201a. The data write completion notification 607 is received by the CPU 201a via the backend switch 106a, the backend connecting cable 206a, and the backend connecting module 205a.

The CPU 201a that has received the data write completion notification 607 transmits a write completion notification 608 to the IO device 101a. The write completion notification 608 is received by the IO device 101a via the pass through module 202a, the IO connecting cable 204a, and the front end switch 105a. The IO device 101a returns a response indicating the write completion to the host machine based on the write completion notification 608.

As described above, the disclosed storage system is a storage system that is connected to a host machine and inputs or outputs data according to a request from the host machine, and includes a first enclosure (controller enclosure 2) in which a controller 210 including a processor (CPU 201) that controls the storage system is mounted, and one or more second enclosures (expansion enclosure 1, expansion enclosure 3) in which a storage device 104 that stores data transmitted from the host machine is mounted.

Furthermore, an IO device 101 that receives data to be stored in the storage system from the host machine and transmits data output by the storage system to the host machine is provided, and the IO device 101 is mounted in the second enclosure (expansion enclosure 1, expansion enclosure 3).

According to this configuration, efficient measures against heat generation can be achieved by disposing the heat sources separately in the controller enclosure 2 and the expansion enclosures (1, 3).

In particular, it is preferable that the IO devices 101 are not mounted in the controller enclosure 2, that is, the IO devices 101 are collectively mounted in the second enclosure.

Furthermore, in the storage system according to the first example, the first enclosure (controller enclosure 2) and the second enclosure (expansion enclosure 1) are connected by a connecting cable (unified connecting cable 203).

The processor mounted in the controller 210 controls the IO device 101 mounted in the second enclosure (expansion enclosure 1) through the connecting cable, receives data received by the IO device 101 from the host machine from the IO device 101 through the connecting cable, and transmits data to be transmitted to the host machine to the IO device 101.

The processor further controls the storage device 104 mounted in the second enclosure (expansion enclosure 1) via the connecting cable, transmits data to be stored in the storage device 104 to the storage device 104 via the connecting cable, and receives data output by the storage device 104 from the storage device 104.

As described above, if a configuration in which the connecting cable is shared between the IO device 101 and the storage device 104 is adopted, the wiring can be simplified.

Furthermore, in the storage system according to the second example, the first enclosure (controller enclosure 2) and the second enclosure (expansion enclosure 1) are connected by a connecting cable of a first group and a connecting cable of a second group different from the connecting cables of the pair of groups.

The processor controls the IO device 101 mounted in the second enclosure (expansion enclosure 1) through the connecting cable (IO connecting cable 204) of the first group, receives data received by the IO device 101 from the host machine from the IO device 101 through the connecting cable of the first group, and transmits data to be transmitted to the host machine to the IO device 101.

The processor further controls the storage device 104 mounted in the second enclosure (expansion enclosure 1) via the connecting cable (backend connecting cable 206) of the second group, transmits data to be stored in the storage device 104 to the storage device 104 via the connecting cable of the second group, and receives data output by the storage device 104 from the storage device 104.

Therefore, by separating the transferring path from the processor to the IO device and the transferring path from the processor to the storage device 104, the data transfer between the IO device and the storage device does not interfere with each other, and thus an efficient heat generation countermeasure can be achieved while simplifying each transferring control.

Note that the “group” in the connecting cables of the first group and the connecting cables of the second group indicates a difference in application, and does not mean that physical properties or structures are different. Furthermore, one group does not necessarily have a plurality of cables, and the number of cables belonging to one group may be one or more. For example, in a case where there are a plurality of cables for controlling the IO devices 101, the plurality of cables become the connecting cables of the first group.

In addition, in the storage system of the disclosure, the first enclosure (controller enclosure 2) includes two or more controllers 210, the IO device 101 mounted in the second enclosure (expansion enclosure 1, expansion enclosure 3) is controlled by the processor included in one controller 210 of the two or more controllers 210 mounted in the first enclosure (controller enclosure 2), and the IO device 101 transmits data received from the host machine to the processor of the one controller 210 and receives data to be transmitted to the host machine from the processor of the one controller 210.

The storage device 104 mounted in the second enclosure (expansion enclosure 1, expansion enclosure 3) is controlled by the processors of two or more controllers 210 among the controllers 210 mounted in the first enclosure (controller enclosure 2), receives data to be stored in the storage device 104 from the processors of the two or more controllers 210, and transmits data output by the storage device to the processors of the two or more controllers.

With this configuration, the controller can be made redundant, and the performance of transmitting and receiving data of the storage device can be enhanced.

Note that the present invention is not limited to the examples described above, and includes various modified examples. For example, the examples described above have been described in detail for the sake of easy understanding of the present invention, and are not necessarily limited to those having all the described configurations. In addition, the configuration is not limited to deletion, and the configuration can be replaced or added.

For example, in the above example, the storage system including two second enclosures (expansion enclosures) has been exemplified, but the number of expansion enclosures may be one or three or more. The number of controllers is also arbitrary. In addition, even in a configuration in which IO devices are provided in both the first enclosure (controller enclosure) and the second enclosure (expansion enclosure), dispersion of heat generation of the IO devices can be achieved. As a configuration of the second enclosure (expansion enclosure), the storage device and the IO device merely need to be mountable, and the second enclosure (expansion enclosure) in which the storage device is not mounted may be provided to add the IO device.

What is claimed is:

1. A storage system that is connected to a host machine and inputs or outputs data according to a request from the host machine, the storage system comprising:
a first enclosure in which a controller including a processor that controls the storage system is mounted; and
one or more second enclosures in which a storage device that stores data transmitted from the host machine in the storage device is mounted, wherein
an IO device that receives data to be stored in the storage system from the host machine and transmits data output by the storage system to the host machine is further provided, and
the IO device is mounted in the second enclosure.

2. The storage system according to claim 1, wherein the IO devices are collectively mounted in the second enclosure.

3. The storage system according to claim 1, wherein
the first enclosure and the second enclosure are connected by a connecting cable,
the processor controls the IO device mounted on the second enclosure via the connecting cable, receives data received by the IO device from the host machine from the IO device via the connecting cable, and transmits data to be transmitted to the host machine to the IO device via the connecting cable, and
the processor further controls the storage device mounted in the second enclosure via the connecting cable, transmits data to be stored in the storage device to the storage device via the connecting cable, and receives data output by the storage device from the storage device via the connecting cable.

4. The storage system according to claim 1, wherein
the first enclosure and the second enclosure are connected by a connecting cable of a first group, and a connecting cable of a second group different from the first group,
the processor controls the IO device mounted on the second enclosure via the connecting cable of the first group, receives data received by the IO device from the host machine from the IO device via the connecting cable of the first group, and transmits data to be transmitted to the host machine to the IO device via the connecting cable of the first group, and
the processor further controls the storage device mounted in the second enclosure via the connecting cable of the second group, transmits data to be stored in the storage device to the storage device via the connecting cable of the second enclosure, and receives data output by the storage device from the storage device via the connecting cable of the second group.

5. The storage system according to claim 1, wherein
the first enclosure has two or more of the controllers mounted,
the IO device mounted in the second enclosure is controlled by the processor included in one controller of the two or more controllers mounted in the first enclosure, transmits data received by the IO device from the host machine to the processor of the one controller, and receives data to be transmitted to the host machine from the processor of the one controller, and
the storage device mounted in the second enclosure is controlled by the processors of two or more controllers among the controllers mounted in the first enclosure, receives data to be stored in the storage device from the processors of the two or more controllers, and transmits data output from the storage device to the processors of the two or more controllers.
